(19) United States
(12) Patent Application Publication
(10) Pub. No.: US 2011/0047539 A1
(43) Pub. Date: Feb. 24, 2011

(54) SOFTWARE DEFINED RADIO MANAGEMENT

(75) Inventors: Jukka Pekka Reunamäki, Tampere (FI); Antti Piipponen, Tampere (FI)

Correspondence Address: Locke Lord Bissell & Liddell;IP Docket Department, 3 World Finanial Center, New York, NY, 10281-2101, US

(73) Assignee: NOKIA CORPORATION, Espoo (FI)

(21) Appl. No.: 12/546,222

(22) Filed: Aug. 24, 2009

(51) Int. Cl. G06F 9/445

(52) U.S. Cl. 717/174

(57) ABSTRACT

A system for facilitating the management of reconfigurable communication resources. These reconfigurable communication resources may include, for example, software defined radio (SDR) modules. SDR modules may comprise fixed hardware-level support for a multitude of wireless radios whose operation/protocols are defined at the software level. A variety of software-based radio definitions (e.g., radio software) may be stored on the apparatus, the radio software defining operation/protocol for one or more radios. Radios defined in the stored radio software may be individually loaded into the SDR module in order to emulate the operation (e.g., wireless communication) of corresponding hardware-based radio modules. Loading radios into, or the unloading of radios from, the SDR module may be managed based on decision criteria.

### BACKGROUND

1. Field of Invention

The present invention relates to wireless communication in an apparatus, and in particular, to managing reconfigurable communication resources residing in an apparatus based on decision criteria related to the apparatus, other apparatuses, operational environment, etc.

2. Background

The ability to communicate wirelessly is quickly moving from being a popular feature offered in some apparatuses to essential functionality. This evolution may stem not only from the proliferation of wireless functionality in new products, but also due to wireless-enabled operation being retrofit into existing applications. Emerging wireless communication technology has, in some instances, provided an ability to communicate where no electronic communication was previously available (due to, for example, location issues, harsh environments, high cost, etc.). The expanding number of applications in which wireless technology is being implemented has, as a result, created equally as comprehensive requirements for operating within these areas.

In at least one usage scenario, the implementation of wireless functionality may face challenges due to apparatus limitations. Emerging communication devices need to support more than one type of wireless communication. Moreover, in some instances an apparatus must support different forms of wireless interaction (e.g., voice vs. data, communication of different ranges, etc.) at substantially the same time. This effort is further complicated by the desire that apparatuses become increasingly smaller. Smaller size may limit an apparatus's complexity of operation (e.g., processing ability), ability to take on additional hardware to support enhanced functionality, energy capacity (e.g., battery life), etc. Therefore, a desire for additional wireless communication functionality comes into direct conflict with the desire for smaller form factors.

Again, while the above issues have been discussed with respect to now emerging apparatuses, similar problems may be confronted when implementing wireless functionality into existing applications. Current applications may have operational characteristics that limit the amount of processing, space, power and other similar resources that are available for supporting wireless communication. Therefore, designers are again confronted by the contradiction where enhanced functionality is desired for platforms where operational resources were already scarce.

### SUMMARY

Various example embodiments of the present invention may be directed to a method, apparatus, computer program product and system for facilitating the management of reconfigurable communication resources. These reconfigurable communication resources may include, for example, software defined radio (SDR) modules. SDR modules may comprise fixed hardware-level support for a multitude of wireless radios whose operation/protocols are defined at the software level. A variety of software-based radio definitions (e.g., radio software) may be stored on the apparatus, the radio software defining operation/protocol for one or more radios. Radios defined in the stored radio software may be individually loaded into the SDR module in order to emulate the operation (e.g., wireless communication) of corresponding hardware-based radio modules. In accordance with at least one embodiment of the present invention, the loading or unloading (e.g., replacement) of radios may be managed based on decision criteria.

In at least one example implementation, a requirement for communication may be realized in an apparatus. The apparatus may then evaluate whether a new radio must be installed and/or loaded in order to support the communication requirement. The evaluation may be based on decision criteria in the apparatus. Decision criteria may pertain to, for example, the condition of the apparatus, the condition and/or functioning of other apparatuses with which the apparatus is communicating, the environment in which the apparatus is operating (e.g., known operational conditions pertaining to a certain location), etc. These criteria may first be updated, for example, in instances where the criteria stored in the device is determined to be old, expired, etc. The apparatus may then determine, based on the decision criteria, one or more radios that should be made available in the SDR module in order to support the communication requirement.

The above determination may include at least two different decisions. Initially, a decision may be made regarding whether a radio needs to first be installed in the apparatus. For example, a particular radio may be identified as supported but may not currently be available (e.g., stored) in the apparatus. In such an instance an attempt may be made to first install the radio software into storage within the apparatus. The apparatus may then determine which of the radios stored in the apparatus should be loaded into the SDR module. The SDR module may then utilize one or more of the loaded radios in order to execute the required communication.

In various embodiments of the present invention, a further determination may be made as to whether loaded radio modules may be replaced. For example, if it is determined that a loaded radio module has no further projected communication requirements, the particular radio module may be indicated as replaceable. The apparatus may then replace, either immediately or at a later time, the particular radio with another radio that has predicted impending usage.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1A discloses example apparatuses, systems, configurations, etc. that may be utilized when implementing the various embodiments of the present invention

FIG. 1B discloses further detail regarding an example apparatus configuration that may be utilized when implementing the various embodiments of the present invention.

FIG. 2A discloses an example of a software-defined radio (SDR) module that may be utilized when implementing the various embodiments of the present invention.

FIG. 2B discloses an example operational scenario in accordance with at least one embodiment of the present invention.

FIG. 3 discloses the example levels of a wireless communication architecture in accordance with at least one embodiment of the present invention.

FIG. 4 discloses an example of services being utilized to create service nodes on a billboard in accordance with at least one embodiment of the present invention.

FIG. 5A discloses an example Network on Terminal Architecture in accordance with at least one embodiment of the present invention.

FIG. 5B discloses an example transport table in accordance with at least one embodiment of the present invention.

FIG. 6 discloses an example of communication to a billboard utilizing a connection map in accordance with at least one embodiment of the present invention.

FIG. 7A-7E discloses an example of an application querying and selecting a service in accordance with at least one embodiment of the present invention.

FIG. 8 discloses an example of communication configuration formulation in accordance with at least one embodiment of the present invention.

FIG. 9 discloses an example of location-based functionality that may be utilized when implementing various embodiments of the present invention.

FIG. 10 discloses an example of location-related information usable with at least one embodiment of the present invention.

FIG. 11 discloses an example of communication configuration in accordance with at least one embodiment of the present invention.

FIG. 12 discloses a flowchart for an example communication configuration process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

I. Example System with which Embodiments of the Present Invention may be Implemented

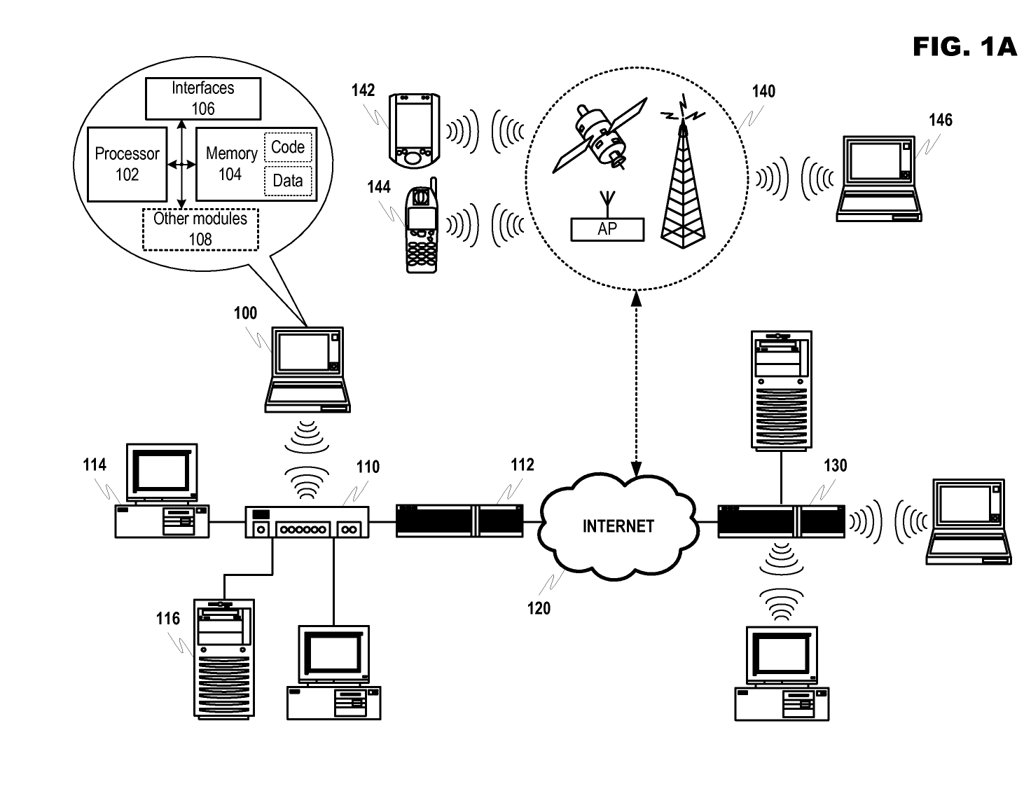

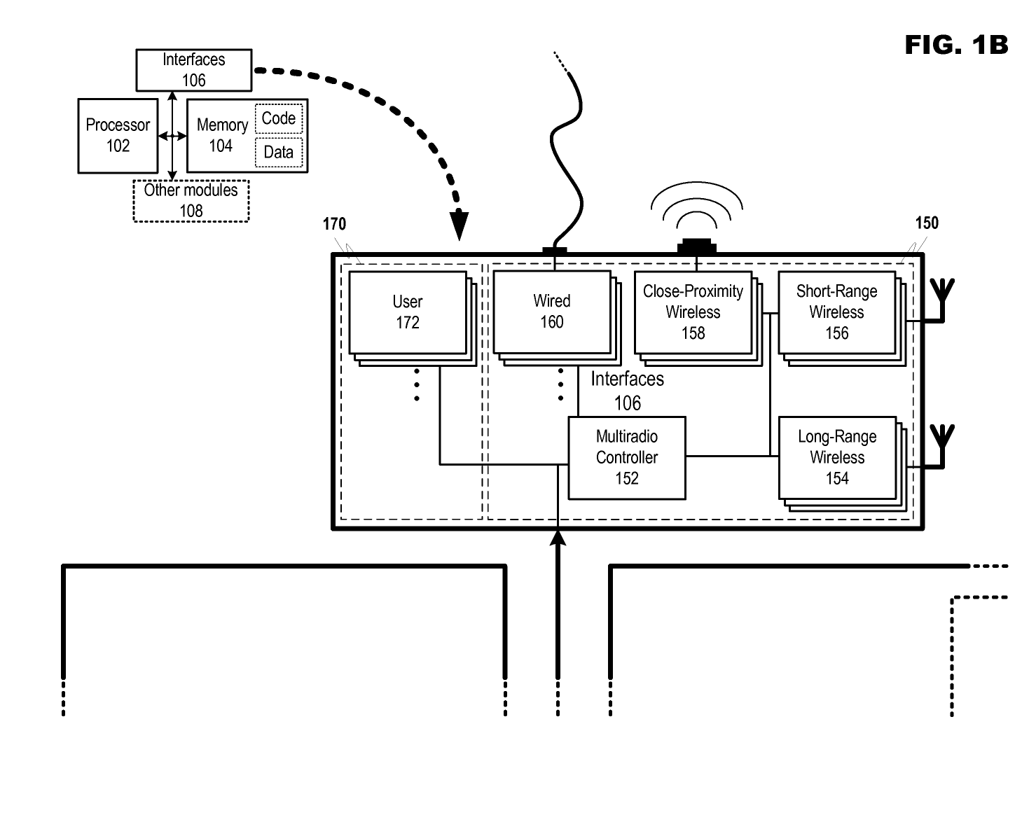

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

Further detail regarding example interface component 106 disclosed with respect to computing device 100 in FIG. 1 is now discussed regarding FIG. 1B. As previously set forth, interfaces 106 may include interfaces both for communicating data to computing apparatus 100 (e.g., as identified at 150) and other types of interfaces 170 including, for example, user interface 172. A representative group of apparatus-level interfaces is disclosed at 150. For example, multiradio controller 152 may manage the interoperation of long range wireless interfaces 154 (e.g., cellular voice and data networks), short-range wireless interfaces 156 (e.g., Bluetooth and WLAN networks), close-proximity wireless interfaces (e.g., for interactions where electronic, magnetic, electromagnetic and optical information scanners interpret machine-readable data), wired interfaces 160 (e.g., Ethernet), etc. The example interfaces shown in FIG. 1B have been presented only for the sake of explanation herein, and thus, are not intended to limit the various embodiments of the present invention to utilization of any particular interface. Embodiments of the present invention may also utilize interfaces that are not specifically identified in FIG. 1B.

Multiradio controller 152 may manage the operation of some or all of interfaces 154-160. For example, multiradio controller 152 may prevent interfaces that could interfere with each other from operating at the same time by allocating specific time periods during which each interface is permitted to operate. Further, multiradio controller 152 may be able to process environmental information, such as sensed interference in the operational environment, to select an interface that will be more resilient to the interference. These multiradio control scenarios are not meant to encompass an exhaustive list of possible control functionality, but are merely given as examples of how multiradio controller 152 may interact with interfaces 154-160 in FIG. 1B.

### II. Example Software Defined Radio (SDR) Module

The example of FIG. 1B represents various interfaces as discrete elements within an apparatus. However, instances exist where such discrete elements, such as hardware-based radio modules, may not be appropriate, easy to implement, etc. For example, mobile apparatuses may have space or power limitations that discourage the use of individual hardware-based radio modules. Moreover, hardware based solutions may be considered inflexible with respect to the ability to correct operational issues or expand communication functionality. To alleviate these restrictions, solutions that introduce more variable components are starting to emerge. Some of these solutions may create flexibility through the implementation of software-based elements.

“Radio computers,” which fall within the broader software-defined radio (SDR) concept, include platform architectures in which the different radio systems (e.g., “radios”) are loaded as software (e.g., “radio software”) and in which as single HW/SW platform can be used to implement different wireless connectivity features on shared processing resources. Radio software may define operation and protocols corresponding to cellular communication, local connectivity, broadcast, navigation, etc., and they can be integrated into legacy (existing) radio systems or form totally new radios. Further, “cognitive” radios may include the ability to sense the surrounding environment and to share this information with peers. The sensed information may be utilized, for example, in distributed sensing strategies that allow apparatuses to make localized decisions in view of the entire environment when configuring communication.

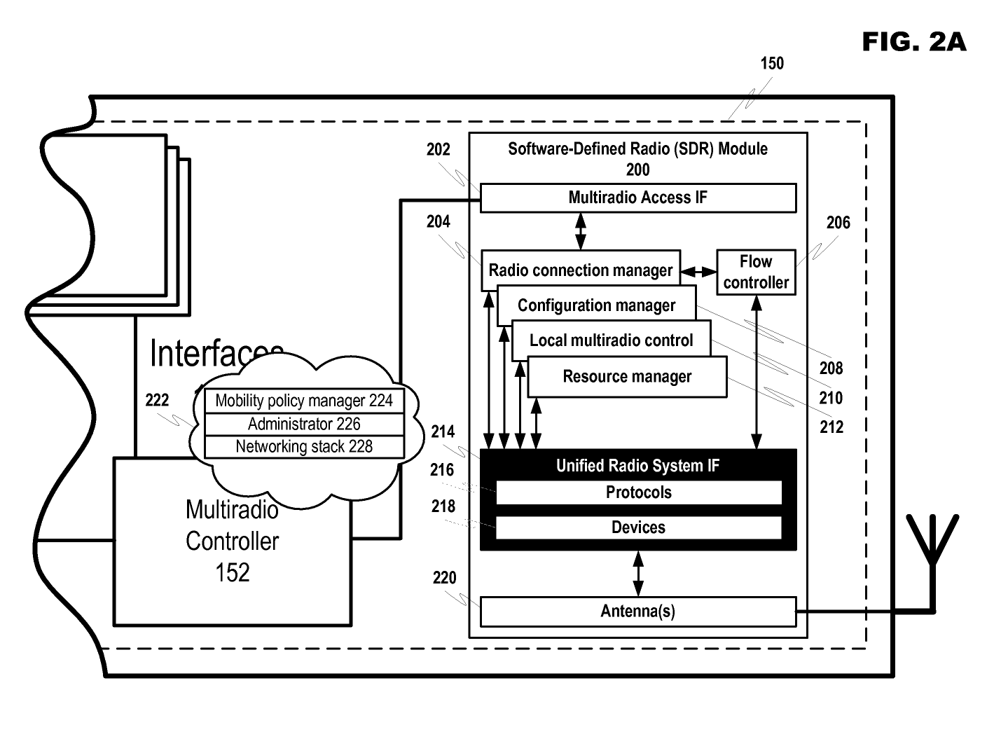

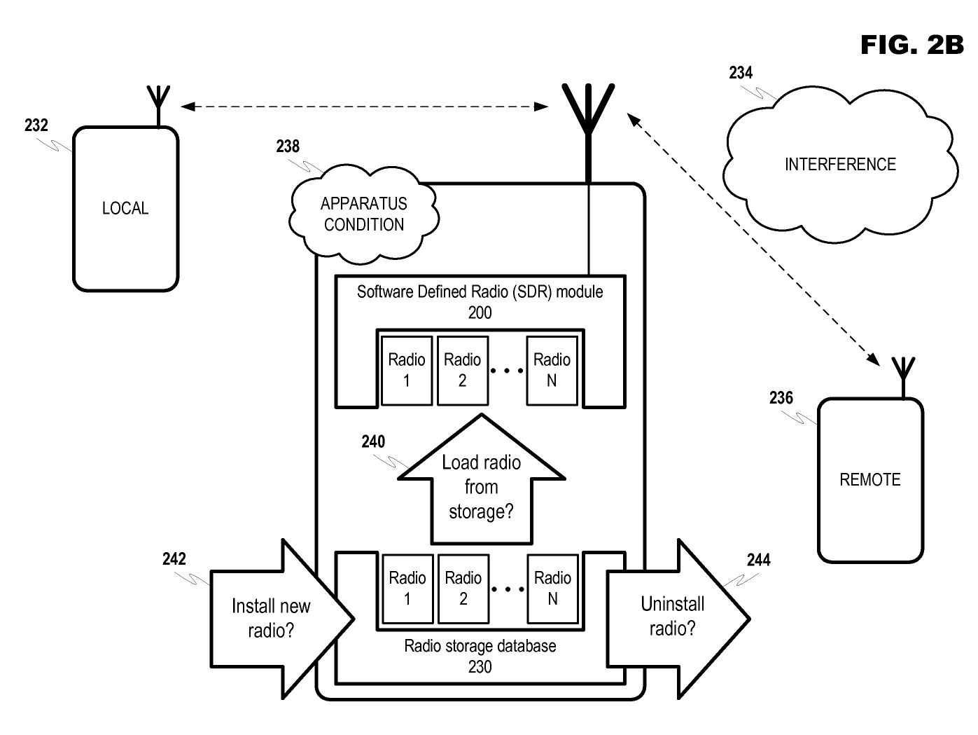

An example implementation of a software-defined radio (SDR) module usable in accordance with various embodiments of the present invention is disclosed in FIG. 2A. Initially, a partial representation of apparatus level interfaces 150 within interfaces 106 (as previously described in regard to the example operational environment of FIG. 1A) is shown. While SDR module 200 is being implemented in FIG. 2A, interfaces 106 may still employ one or more discrete hardware-based communication modules for supporting interfaces including any of long-range wireless interfaces 154, short-range wireless interfaces 156, close-proximity wireless interfaces 158 and wired interfaces 160. Combined hardware and software-based technologies may be employed, for example, in situations where specialized hardware is required to support particular communication transports, it is more economical to implement a hardware-based solution for a particular communication transport, an SDR module 200 and a hardware-based module are used to support transports that often operate concurrently (e.g., transports that do not interfere with each other, and therefore, can operate at the same time), etc. Overall, the configuration of systems usable with various embodiments of the present invention are not limited to the specific implementation shown, and thus, various example embodiments may incorporate combinations of software-based and hardware-based communication technologies.

FIG. 2A discloses an example implementation where SDR 200 may interact with multiradio controller 152 and other aspects of computing device 100 via various communication paths (e.g., wired or wireless buses) for conveying data within the apparatus. For example, SDR 200 may include multiradio access interface 202 configured for the transmission and reception of delay-sensitive information within computing device 100. In addition, flow controller 206 may interact with programs (e.g., operating system components, utilities, high level applications, etc.) generally operating in computing device 100 in order to regulate the flow of messages being sent from, and being received into, SDR 200. These communication interactions within computing device 100 may cause multiradio access interface 202 and/or flow controller 206 to interact with various software components in SDR 200 in order to emulate hardware-based radio modules.

For example, information received via multiradio access interface 202 and/or flow controller 206 may be used to determine how SDR 200 is to be configured. This configuration may include radio connection manager 204 receiving data from multiradio access interface 202 and/or flow controller 206. This data may include at least one of instruction information (e.g., rules or preferences regarding which transports to utilize in certain situations) and messages awaiting transmission. Radio connection manager 204 may then interact with some or all of configuration manager 208, local multiradio control 210 and resource manager 212 when configuring SDR 200. For instance, configuration manager 208 may provide information regarding resources required for supporting a particular wireless transport, and resource manager 212 may determine if these resources are available. If radio connection manager 204 decides that it is possible to configure SDR 200 to support the particular wireless transport (e.g., in view of the information provided by the other modules) then local multiradio control 210 may implement the configuration. While an example of a usable configuration for SDR 200 has been disclosed in FIG. 2A, other configurations are possible in accordance with various embodiments of the present invention. For example, the functionality of multiradio controller 152 and local multiradio controller 210 may be implemented as a single functional element in interfaces 106.

In implementing a particular radio configuration, some or all of software modules 202-212 may interact with unified radio system interface 214 in order to establish settings that will allow SDR 200 to emulate a desired radio functionality. For example, unified radio systems may include both protocol information 216 and device information 218 usable when replicating the functionality of hardware-based radios. The configured software resources may then utilize hardware resources (e.g., antennas 220) when sending and/or receiving wireless messages. For example, information in protocols 216 and devices 218 may be accessed and/or manipulated in order to emulate the functionality of a radio module that is configured to operate using one or more wireless transports (e.g., Bluetooth, WUSB, etc.) and at the conclusion of activity may be reconfigured to support pending communications via another wireless transport (e.g., WLAN).

In accordance with various embodiments of the present invention, SDR module 200 may interact with various program modules 222 residing in multiradio controller 152 or elsewhere within the control system of computing device 100. Program modules 222 may provide apparatus-side coordination of communication when, for example, multiple SDR modules 200 are active, or when SDR module 200 is active at the same time as a hardware-based radio module. Example program modules 222 may include, but are not limited to, mobility policy manager 224, networking stack 228 and administrator 226. In at least one scenario, mobility policy manager 224 may define preferences and/or rules that control utilization of communication transports in the apparatus. These preferences and/or rules may be based on various apparatus, application or user-defined characteristics. For example, the number of messages pending for each transport in networking stack 228 may determine the next transport that will be implemented (e.g., a priority between the active transports), and therefore, the next configuration for SDR module 200. In making this determination, mobility policy manager 224 may work with administrator 226 to create an operational schedule so that communication may continue within the guidelines set forth in the aforementioned preferences and/or rules.

FIG. 2B presents a general operational scenario that will be utilized herein when explaining the various embodiments of the present invention. However, the present invention is not strictly limited to the situation set forth in FIG. 2B, and may therefore also be implemented in other applicable communication managements situations. The apparatus presented in FIG. 2B comprises at least one SDR module 200. In support of module 200, radio storage database 230 may also be present in order to store radio software. Radio software may include configuration information (e.g., radios) that would be needed when configuring SDR module 200 to emulate hardware-based radio operation such as protocols 216 and devices 218 as shown in FIG. 2A.

Example apparatus-related activities are also described in FIG. 2B: installing new radios into the apparatus as shown at 242, loading radios from radio storage database 230 into SDR module 200 as shown at 240, and uninstalling radios from the apparatus as shown at 244. New radio installation activities 242 may be triggered by the realization that radio software associated with desired radio operation that is supported by the apparatus is not resident in radio storage database 230. Installing new radios as shown at 242 may entail, for example, wired or wireless communication with a configuration provider that can transmit the required radio software to the apparatus. Some or all of the radio software may then be stored in radio storage database 230. In some instances, one or more radios defined within the installed radio software may be desired to support pending communication operations in the apparatus. The one or more desired radios may then be loaded into SDR module 200 as shown at 240. The loading activity 240 may involve accessing radio definition information in the radio storage database and using the radio definition information to configure the operation of SDR module 200. In accordance with at least one embodiment of the present invention, SDR module 200 may support multiple concurrent radio configurations. The ability to load more than one radio into SDR module 200 may allow for quick changeovers from one type of communication to another, or in some cases, the ability to carry out communication activities using a plurality of communication transports at substantially the same time (e.g., under control of multiradio controller 152 and/or local multiradio control 210). Radio uninstallation activities 244 may be triggered when, for example, no current or anticipated usage exists for one or more radios. Uninstalling radios with no actual or planned usage from radio storage database 230 not only creates an available storage space for installing new radios at 242, but may also result in other benefits such as powering down unused memory areas, processor cores, signal interfaces, etc. in apparatuses, which may help to conserve vital resources in situations where these resources are constrained (e.g., mobile communicators).

While FIG. 2B discloses how radios may be installed, loaded or uninstalled, an effective method for identifying the radios on which these activities should be performed has not yet been addressed. The apparatus shown in FIG. 2B may support numerous radios in view of the radios that are installed in radio storage database 230, and even more radios may be available for installation in the apparatus. However, no strategy has been discussed for identifying the radios that are to be installed/loaded. The choice of radios to install/load may be influenced by a number of factors including, but not limited to, apparatuses 234 operating close to, and possibly communicating with, the apparatus, interference 236 existing in the operational environment, the operation of remote apparatuses 236 with which the apparatus is interacting, current apparatus condition, etc. These factors may, for example, eliminate certain radios from being useful due to a lack of support in another apparatus with which communication is desired, may discourage use of certain radios due to possible interference and other performance-related situations, and may make the use of some radios preferable due to the particular features that are available through use of a communication transport (e.g., security, error correction, speed, etc.)

In accordance with various embodiments of the present invention, the resolution to issues such as those presented in FIG. 2B may be rooted in the availability of decision criteria to apparatuses so that “intelligent” decisions may be made when deciding whether to install/load radios into the apparatus. For example, some network communication architectures may include the ability to provide information such as apparatus condition, functionality and configuration information that may be useful in expediting the radio selection process. These communication architectures may make information corresponding to other networked apparatuses available for use as decision criteria. Example implementations, in accordance with at least one embodiment of the present invention, may operate using such architectures operating alone or in conjunction with other (e.g., environmental, location-related, etc.) decision criteria providing processes.

### III. Example Network on Terminal (NoTA) Architecture.

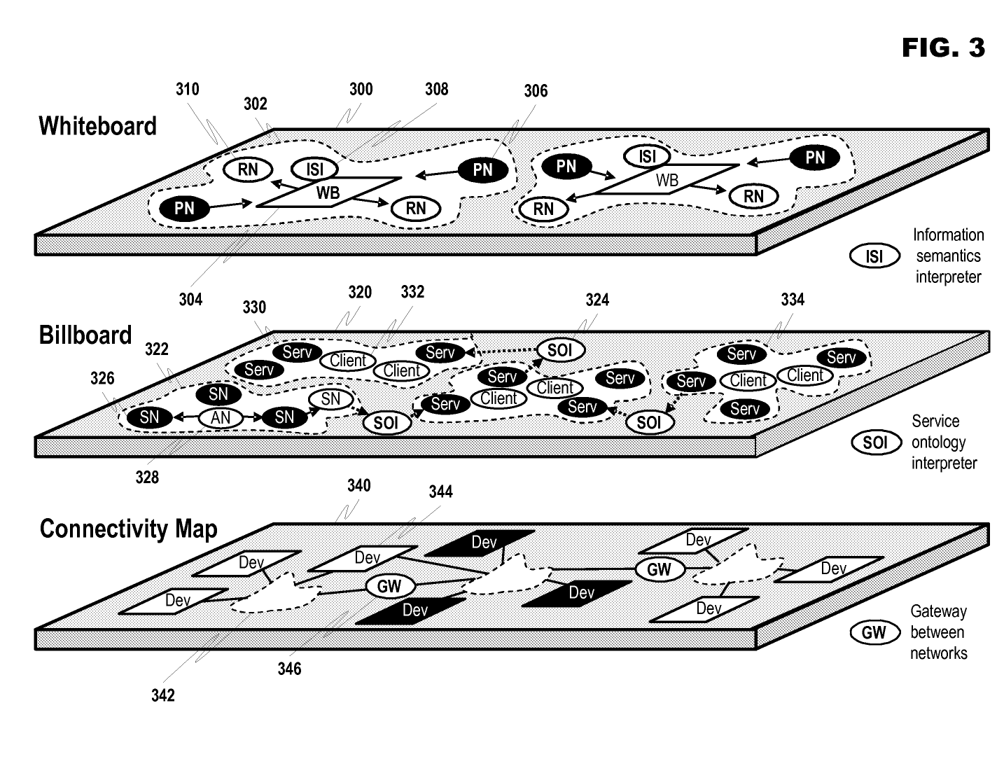

An example wireless communication architecture in accordance with at least one embodiment of the present invention is disclosed in FIG. 3. While example embodiments focus mainly on Billboard 320 and Connectivity Map 340, Whiteboard 300 has also been disclosed for contextual purposes. Whiteboard 300 is the highest level of operation in the architecture. At this level, operational groups 302 may be formed including whiteboards 304 and various application nodes. Application nodes may correspond to various applications existing on a plurality of wireless communication devices, and may be utilized to exchange information between these applications, for example, by placing data into, and removing data from, whiteboard 304. For example, the types of nodes may comprise proactive nodes (PN) 306 that are utilized to place information into whiteboard 304, reactive nodes (RN) 310 are utilized to take information from whiteboard 304. Information semantics interpreter (ISI) 308 may be utilized to link different whiteboards together. Utilizing these constructs, Whiteboard 304 may provide a standardized means for application interaction that overcomes many incompatibilities.

Billboard level 320 facilitates interaction between services available on the one or more devices. For instance, Billboard level 320 provides sharing of service-related information (e.g., service identification information, functionality, etc.), as well as information that may be necessary when accessing and/or utilizing each service. Services 330 and clients 320 that may utilize these services may be organized in service domains 322. In at least one scenario, service domains 322 may correspond to a particular protocol, such as Universal Plug and Play (UPnP), Bluetooth Service Discovery Protocol (BT SDP), Bonjour, etc. In each service domain 322, services 330 may be represented by service nodes (SN) 126, and likewise, application nodes (AN) 328 may correspond to applications. Further, service domains 322 may interact utilizing service ontology interpreters (SOI) 324. SOI 324 allows service domains 322 to interact with other service domains 322 in the service level, even if service domains 322 reside on different wirelessly-linked devices (e.g., to provide access information to other service domains 322).

Connectivity map 340 may define available connection methods, possible routing methods and topology for the apparatuses that are participating in whiteboard 300 and billboard 320. In at least one embodiment of the present invention, devices 344 may be linked in directly connected groups 342. Examples of directly connected groups of devices (Dev) 342 may include devices connected via a Bluetooth piconet, a WLAN network, a wUSB wireless link, etc. Each directly connected group of devices 342 may further be linked by gateways (GW) 346.

### IV. Service Node Implementation

Services may be defined as functionality offered and/or derived from software programs. Services can pertain to all aspects of device functionality and can be provided, for example, by an operating system loaded on an apparatus, or alternatively, may be added to the apparatus by separate software programs related to communication, security, productivity, device resource management, entertainment, etc. According to at least one embodiment of the present invention, service nodes may represent services available on the apparatuses linked by NoTA.

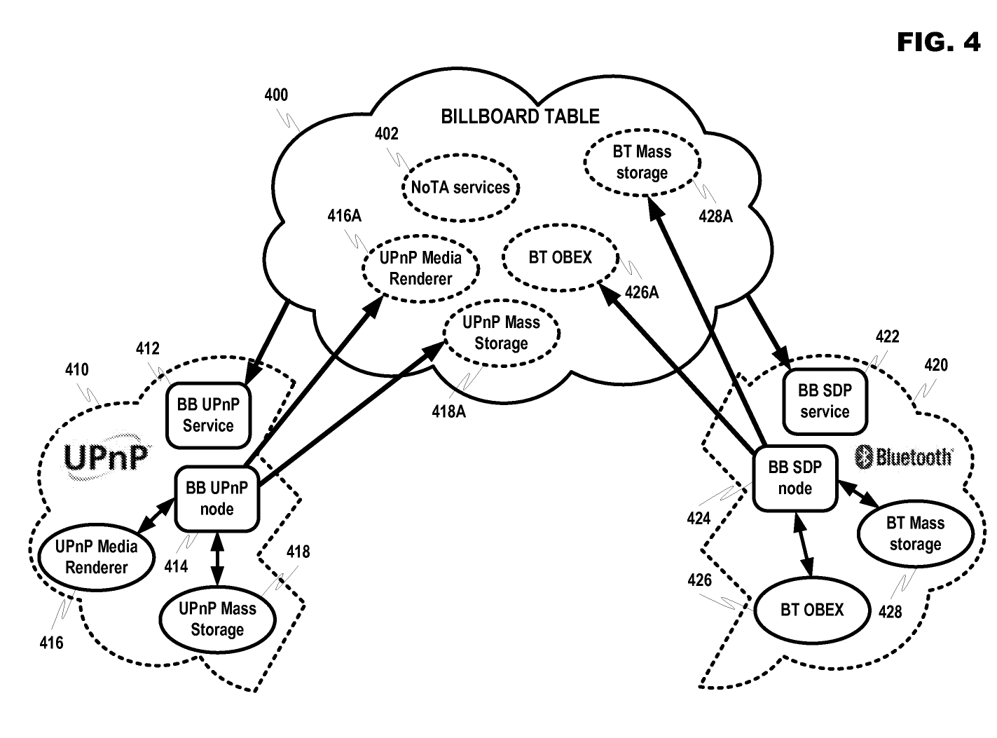

FIG. 4 discloses an example of billboard functionality in accordance with at least one embodiment of the present invention. Billboard 400 may comprise a shared memory space established amongst one or more wired or wireless devices. The scenario disclosed in FIG. 4 may further include a protocol such as UPnP 410 installed on an apparatus, and Bluetooth SDP 420 installed on another apparatus. Billboard 400 may interact with these protocols using one or more services installed these apparatuses, such as example billboard services BB UPnP service 412 and BB SDP service 422. BB services 412 and 422 are typically components of UPnP and BT architecture, but they can also be representative components provided as part of the NoTA.

UPnP 410 may offer services locally to the apparatus on which it is installed. Example services may include UPnP media renderer service 416 and UPnP mass storage service 418. Similarly, in the example of FIG. 4 Bluetooth SDP 420 may provide BT OBEX service 416 and BT mass storage service 428 on a separate apparatus. The particular UPnP and BT services identified in FIG. 4 have been selected only for the sake of example herein, and are not intended to limit the scope of services usable with embodiments of the present invention. While services are normally only accessible to applications residing in the same service domain, NoTA may facilitate interaction between various services and/or applications, regardless of the domain.

At least one embodiment of the present invention may operate by creating service information entries corresponding to services offered on each device in billboard table 400. In the scenario disclosed in FIG. 4, BB UPnP node 414 and BB SDP node 424 may create service information entries UPnP media renderer service 416A and UPnP mass storage service 418A, as well as BT OBEX service 416A and BT mass storage service 428A, respectively. These service information entries may all exist in a common billboard table 400, despite the actual protocols and services residing on separate devices. Further, the service information entries may provide information about services to other services and/or applications, such as the name of the service, service properties, pairing & authentication information utilized in accessing a particular service and/or transport mediums usable with each service. This service information may be obtained, for example, via BB SDP service 424 if billboard table 400 is accessed from the BT domain, or BB UPnP 414 service if billboard table 400 is accessed from the UPnP domain. In architectures such as NoTA, it may also be possible to provide direct access to billboard services. NoTA services 402 may, in accordance with at least one embodiment of the present invention, establish initial communication between participating apparatuses via a common wireless communication transport in order to establish a shared memory space that will be utilized as Billboard table 400.

### V. Underlying Architecture

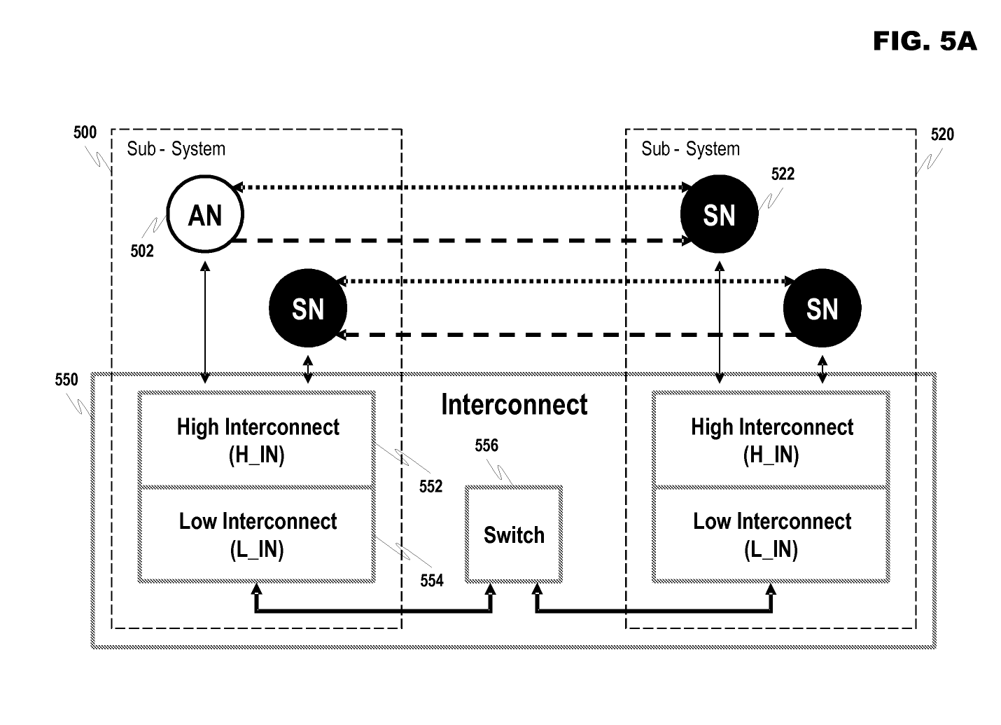

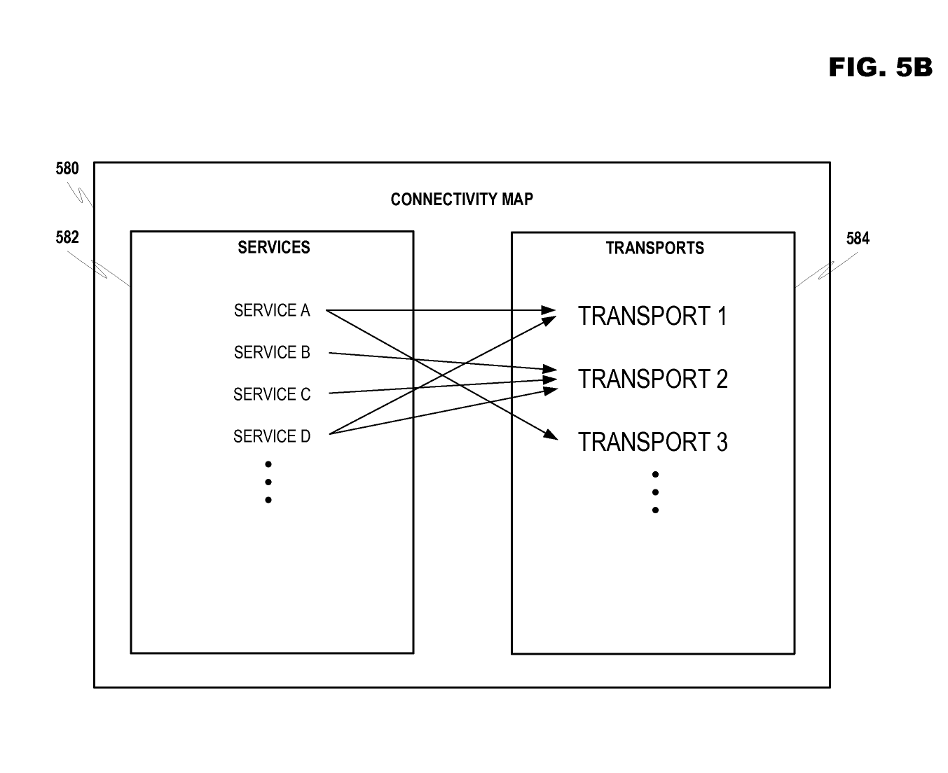

FIG. 5A discloses an example of an underlying logical architecture that may be utilized in implementing NoTA. NoTA may be configured as multiple subsystems (e.g., 500 and 520) coupled by interconnect 550. NoTA interconnect 550 may comprise two layers: High Interconnect (H_IN) layer 552 and Low Interconnect (L_IN) layer 554 that are coupled by switch 556. Low interconnect layer 554 may include ISO/OSI layers L1-L4 and may provide transport socket type interface upwards. High Interconnect layer 552 may act as middleware between L_IN 554 and the higher level Application nodes (AN) 502 and Service nodes (SN) 522 residing in subsystems 500 and 520, respectively. H_IN 552 functionality may provide client nodes (AN 502 or SN 522) direct access to services (without having to disclose the location of the latter). Communication may be connection-oriented, meaning that before any service or data communication takes place, connection setup procedures would need to be carried out. Security features may also be added to countermeasure identified threats. As set forth in the example of FIG. 5, NoTA may provide intra-device service access making it possible to build independent subsystems providing both services and applications. Moreover, example implementations may include several individual NoTA devices involved in direct inter sub-system communication.

FIG. 5B discloses another structure that may be implemented in accordance with various embodiments of the present invention. Connectivity map 580 may associate services available on apparatuses participating in billboard table 400 with communication transports that may be utilized in conjunction with each service. Examples of communication transports may include, but are not limited to, wireless communication mediums such as Bluetooth, WLAN, Bluetooth LE (BTLE), wUSB, etc. In addition, at least one embodiment of the present invention may also apply radio technologies to different protocols (e.g., Bluetooth protocols may be implemented over WLAN). However, the various embodiments the present invention are not specifically limited to using these particular communication transports, and may be implemented with other wired or wireless communication mediums that are usable by services offered by various participating apparatuses. Services (e.g., offered by apparatuses) in FIG. 5B may be listed under services 582, and the corresponding available transports are listed under transports 584. Arrows between services 582 and transports 584 indicate the one or more transport mediums that are usable by each service. Information in connectivity map 580 may, in accordance with various embodiments of the present invention, bind billboard table content (e.g., service offerings) and available apparatus connectivity configuration. This information may be utilized, for example, by applications when determining the communication transports that are usable with a particular service. Where two or more transport mediums are usable, a particular communication medium may ultimately be selected based on characteristics such as speed, traffic, priority of executing the service, other active wireless communication mediums, etc.

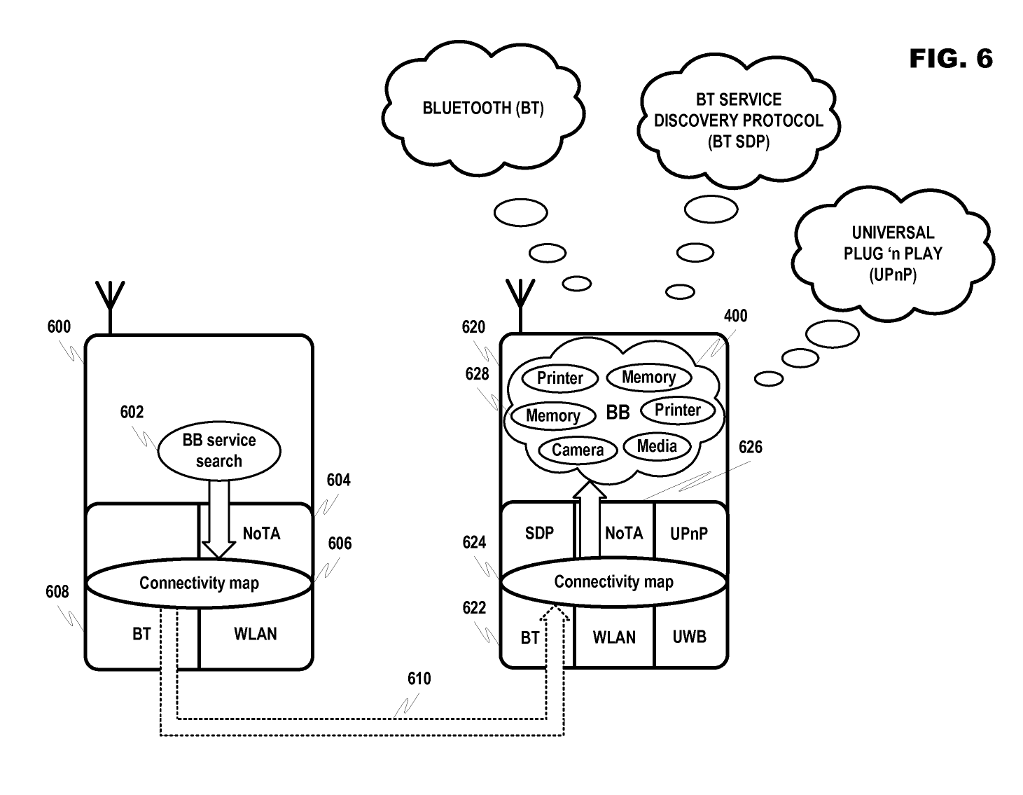

Now referring to FIG. 6, an example depicting a wireless transaction between apparatuses 600 and 620 is disclosed in accordance with at least one embodiment of the present invention. In this instance, BB service search 602 on device 600 may require the use of a particular service. Further, billboard table 400 may reside on device 620. Regardless of the actual location of the service required by BB service search 602, billboard table 400 may be queried to gain access to a corresponding service node. This is because all available service information on the one or more devices participating in billboard table 400 is centrally located, reducing the steps required to access each service, and therefore, increasing the speed of access for available services. In addition, various embodiments of the present invention may include more than one billboard table 400 established between the linked devices. These billboard tables 400 may interact with each other to create a shared information pool that services may access.

BB service search 602 may, for example, utilize NoTA service 604 residing on device 600 in order to access billboard table 400. In this example, connectivity map 606 may identify at least Bluetooth (BT) 608 as a transport medium usable by NoTA service 604. Other communication transports may also be usable, however in this example Bluetooth 608 is selected (e.g., by a user, by BB service search 602, by applications triggering BB service search 602, etc.) Communication link 610 may then be established between apparatuses 600 and 620 via BT 608.

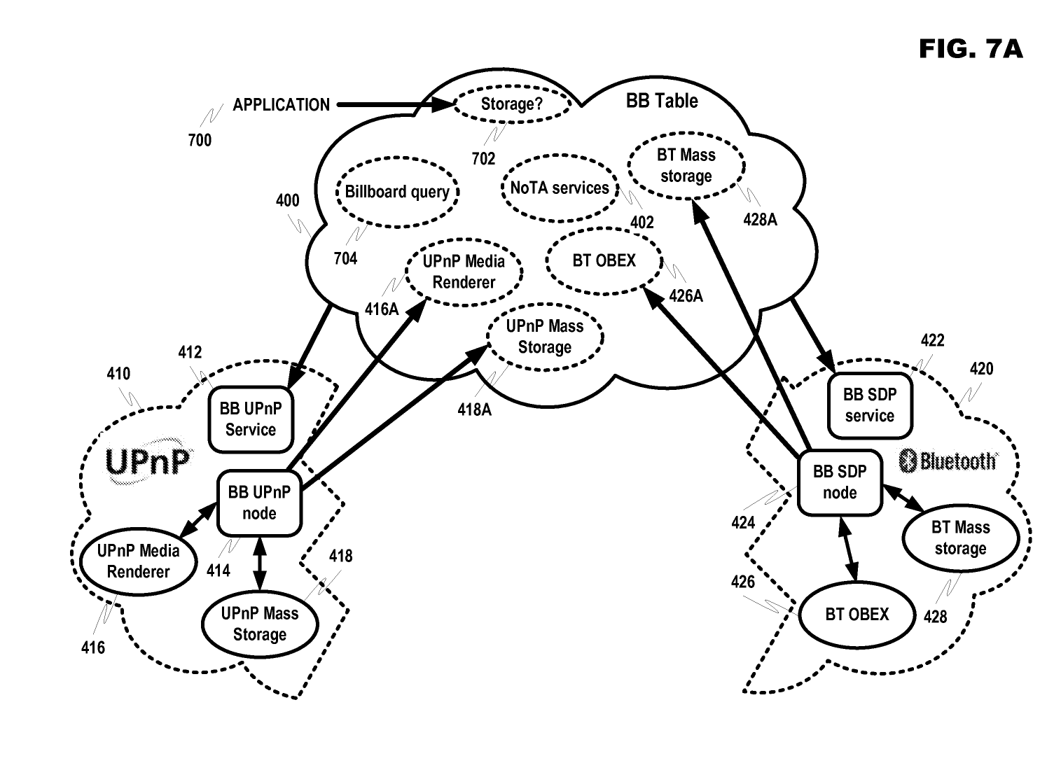

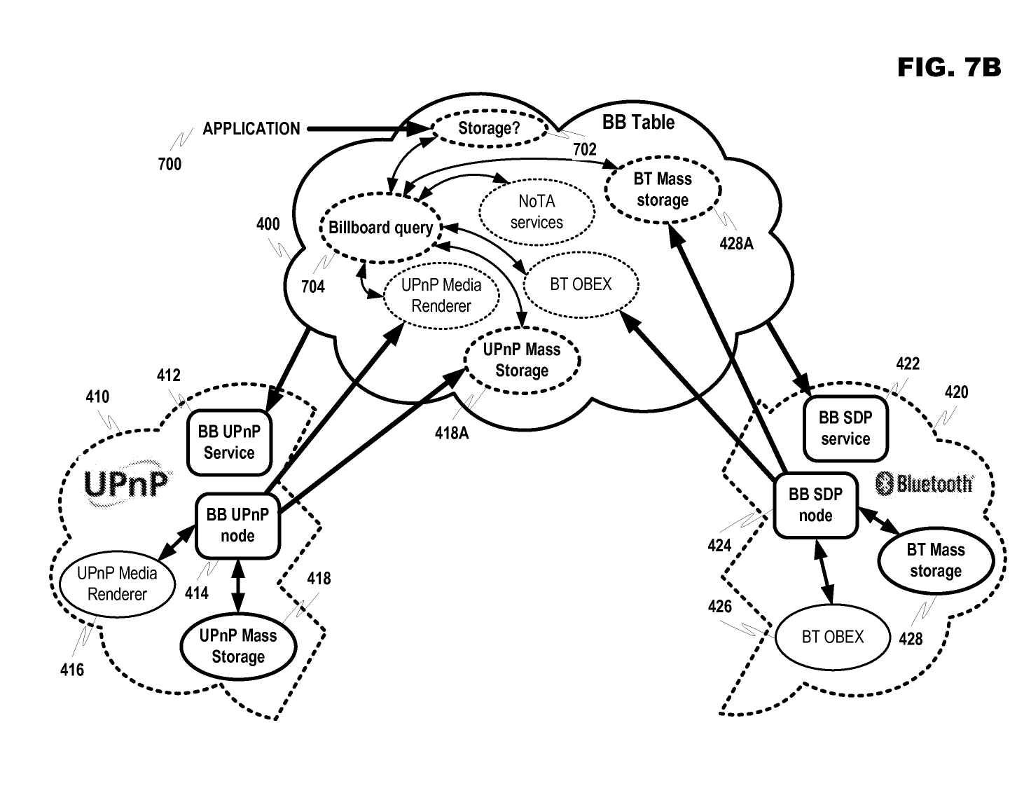

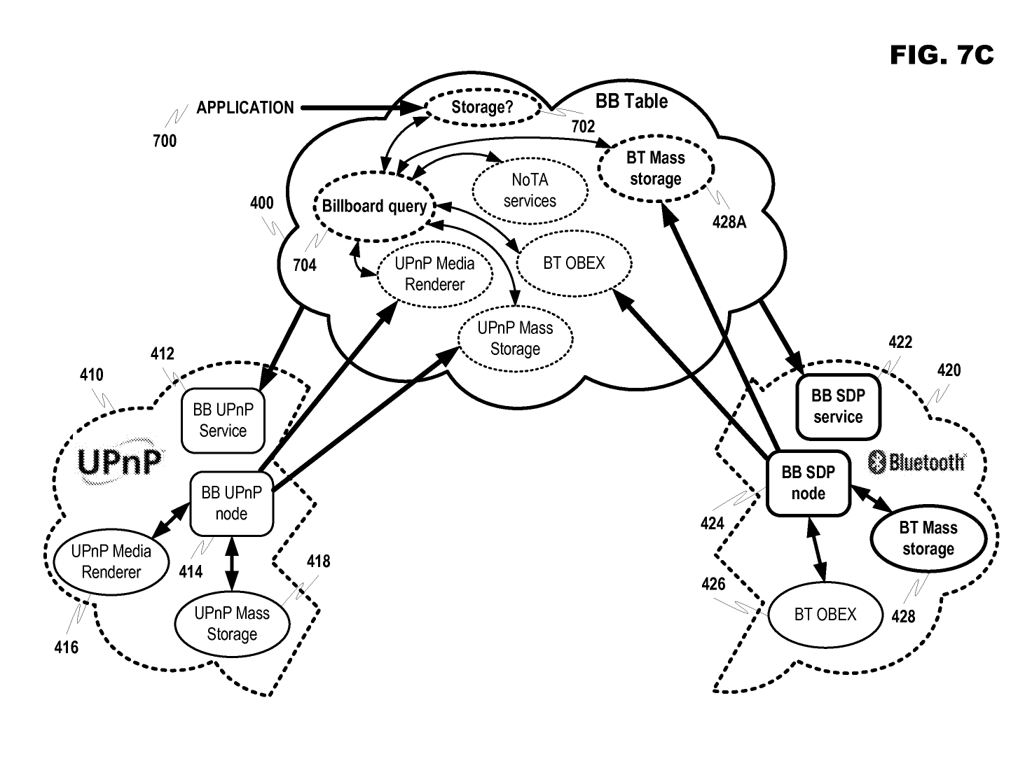

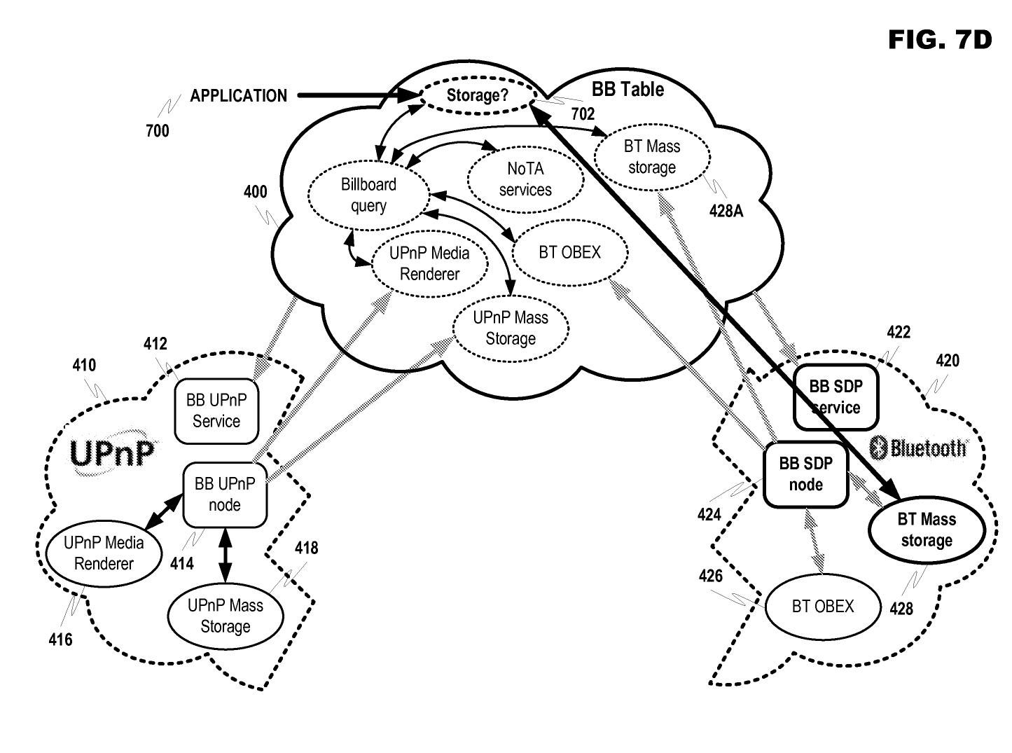

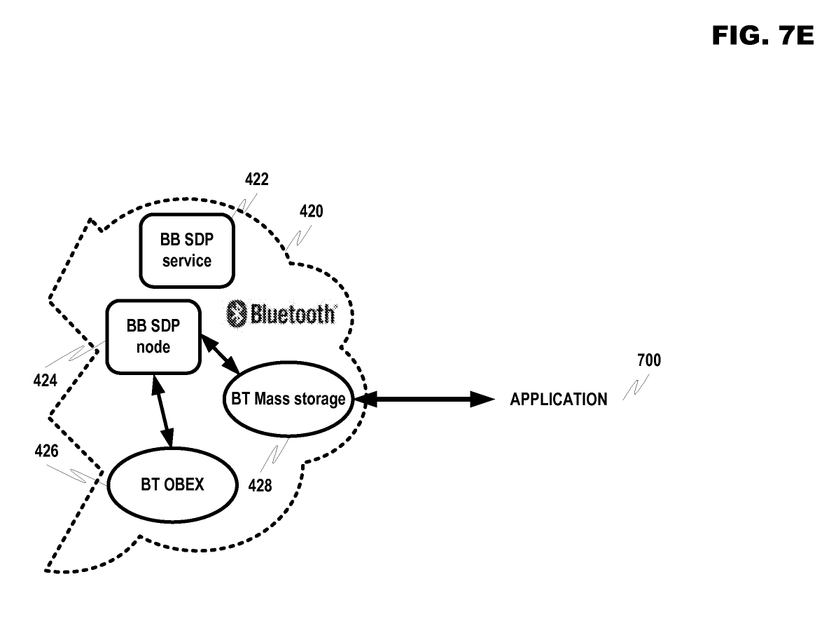

The wireless query sent by apparatus 600 may then be received in apparatus 620. Bluetooth resources 622 in apparatus 620 may be usable by NoTA service 626 as determined by a mapping in connectivity map 624. NoTA service 626 may provide access to query billboard table 400, which may contain various service information entries 628 corresponding to various services available in the linked wireless communication devices. Again, while two apparatuses are shown in the example of FIG. 6, more than two apparatuses may participate in billboard table 400, including service nodes 628 corresponding to services that are offered by each device. BB service search 602 may then query the service information entries 628 available in billboard table 400 in order to determine if any of the services corresponding to service information entries 628 will be suitable for the parameters specified in the search. An example query of billboard table 400 is now described with respect to FIG. 7A-7E.

### VI. Example Application/Service Node Interaction

Example query steps in accordance with at least one embodiment of the present invention are disclosed in FIG. 7A-7E. FIG. 7A discloses a situation wherein application 700 (e.g., executing on one of the apparatuses participating in billboard table 400) has a requirement for storage as indicated at 702. As a result, access to a service providing storage activities may be desired in order to support the requirements of application 700. In order to locate suitable services for application 700, a search may be performed, at least in part, by billboard query 704.

An inquiry process in accordance with at least one embodiment of the present invention is shown in FIG. 7B. Storage requirement 702 may be referred to billboard query 704, which queries all of the service nodes in billboard table 400 in order to identify services that may fulfill the requirements of Application 700. In FIG. 7B two service nodes (UPnP mass storage 418A and BT mass storage 428A) have been identified as potentially corresponding to services appropriate for storage requirement 702. Billboard query 704 may further obtain information related to the services from their respective nodes. For example, property information may be obtained from service information entries 418A and 428A to application 700 through billboard query 704. Information regarding transport mediums that are usable by each service may also be obtained through the use of connectivity map 580. The property and transport information may be used when selecting a service for supporting application 700. For example, the properties of a service may be more useful for, or accessible to, application 700. Services may also be selected because a transport usable with a service is better suited for the activity to be performed because other usable transport mediums are already supporting a large amount of message traffic, would experience interference, would conflict with other transport mediums, etc.

BT mass storage service information entry 428A is selected to support application 700 in FIG. 7C. Selection may be carried out automatically by control elements residing in the apparatuses participating in billboard table 400, by application 700, by user selection of preferred services and/or transports, etc. Billboard query 704 may then obtain the information necessary for utilizing BT Mass storage service 428 from BT mass storage service information entry 428A. The information may include property and transport information that may be further conveyed to application 700 in order to facilitate a direct link between application 700 with BT Mass storage service 428. The resulting direct linkage is disclosed in FIG. 7D, which may be followed by interaction between application 700 and BT Mass storage service 428 as shown in FIG. 7E.

### VII. Example of Resource Provider Selection.

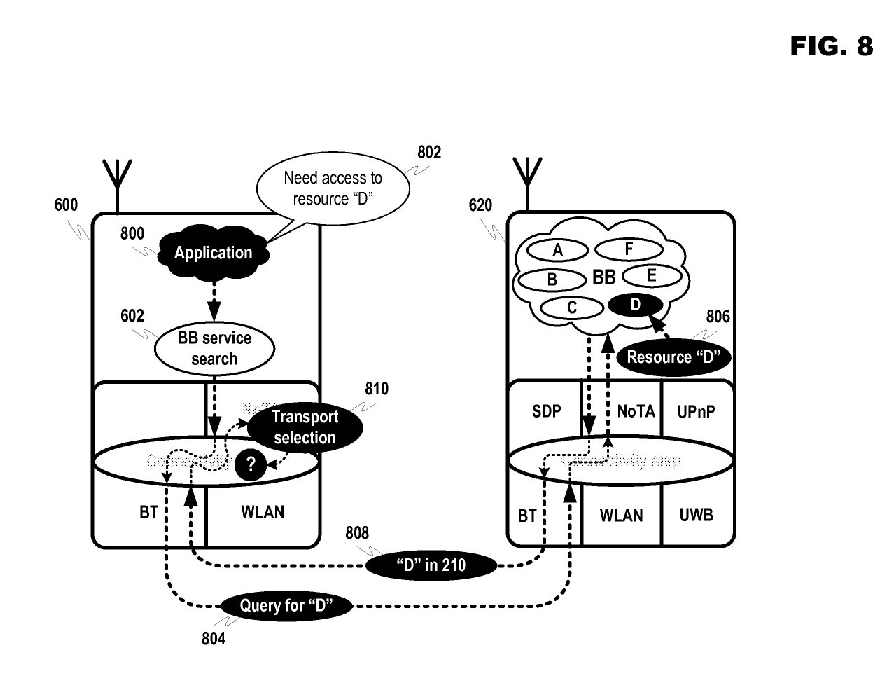

Now with respect to FIG. 8, drawing elements that were previously discussed in regard to other figures are not identified in FIG. 8 in order to reduce the complexity of the figure. In accordance with at least one example embodiment of the present invention, FIG. 8 discloses a possible interaction between apparatuses 600 and 620. Interaction between only two apparatuses has been disclosed in FIG. 8 for the sake of explanation herein, and thus, the present invention is not limited to use with only two apparatuses. Interaction in this scenario may be initiated by any participating apparatus, but in the disclosed example is triggered by application 800 in apparatus 600. Application 800 may be, for example, a software/ program module that upon activation, execution or user interaction creates requirements to access a resource (e.g., as shown at 802).

In accordance with the previously disclosed example embodiments of the present invention, BB search 602 may utilize a transport, such as Bluetooth™ (BT), to perform query 804 of available resources in the NoTA environment. The same transport may further be used to exchange connectivity map information, which may eventually be utilized in transport selection 710 when appropriate transports are to be selected. The accumulation of this available resource information may help facilitate the identification of potential providers for requested resources, such as resource “D” requested by application 800. For example, information in BB 400 may disclose that resource “D” 806 actually resides on apparatus 620 in the NoTA environment, and therefore, apparatus 620 is capable of acting as a “provider” for resource “D” to apparatus 600.

A response 808 to inquiry 804 may be returned identifying one or more potential resources (e.g., services, databases, etc.) residing on at least one provider (in this case apparatus 620). However, subsequent transactions cannot be limited to utilizing the transport that was initially selected in order to perform the query. For example, high speed, low power, low throughput transports like Bluetooth LE (BTLE) may be adequate for performing initial queries, but would not be likewise appropriate for subsequent communication if large amounts of data are to be conveyed, a low amount of errors is required or other similar requirement exist. As a result, a determination may be made at 810 as to maintain use of the current transport or to select a new transport based, for example, on various decision criteria such as described herein.

### VIII. Location-Based Decision Criteria

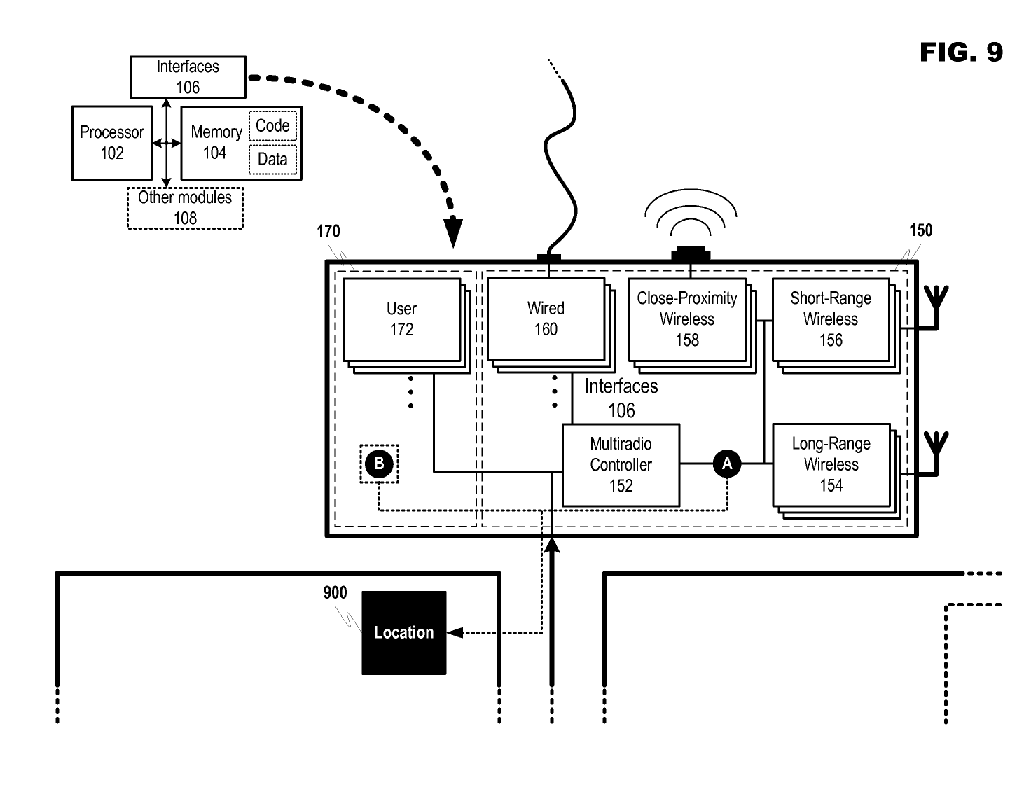

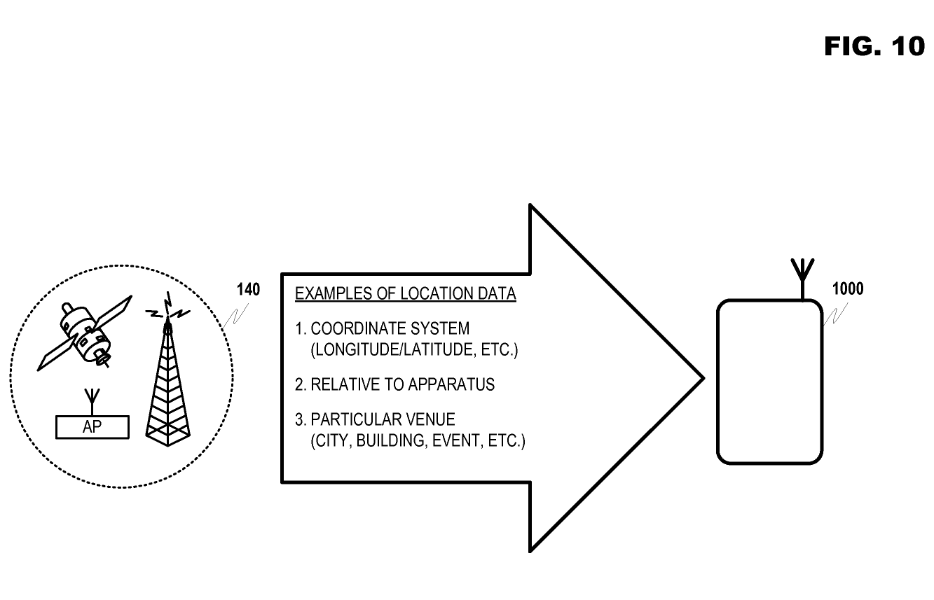

FIG. 9 discloses an example of another potential source for decision criteria that may be used alone or in conjunction with decision criteria that is available in NoTA operational environments. While location-related information may be used primarily to identify the current position of an apparatus, current apparatus position may correlate to other information that, for example, may describe the environment in which an apparatus is operating. FIG. 9-10 describe how location information may be obtained by, reported to, and used in a receiving apparatus.

FIG. 9 expands upon the example configuration of interfaces 106 as originally set forth in FIG. 2. In accordance with at least one embodiment of the present invention, location information 900 may be provided to processing resources in an apparatus (e.g., processor 102) from various sources. These sources are generally categorized as “A” and “B” in FIG. 9. “A” in FIG. 9 corresponds to location information provided by existing apparatus-level communication interfaces 150. For example, computing apparatus 100 may register with a long-range wireless network, establish a short range wireless link, scan machine-readable information from a tag or physically connect to a wireless network via one of the interfaces disclosed at 150. The network or apparatus with which computing apparatus 100 is communicating may then, at some point after a link is negotiated, provide position-related information to computing apparatus 100.

In alternative implementation “B”, usable alone or in combination with the above, an interface reserved specifically for obtaining location-related information may be provided in other interfaces 170. For example, a global positioning system (GPS) receiver may be integrated in, or coupled to, computing apparatus 100 for the provision of location information. Location information may be obtained by the interface upon request, periodically, or in accordance with other data acquisition methods as known in the art. An example of location information sources “A” and “B” being used together may occur in apparatuses having a dedicated-type interface “B” that only operates in particular situations (e.g., when the apparatus is outside to receive satellite signals), and so a type “A” interface may be used to obtain location information when the type “B” interface cannot (e.g., when the apparatus is inside a structure such as an office, home, etc.).

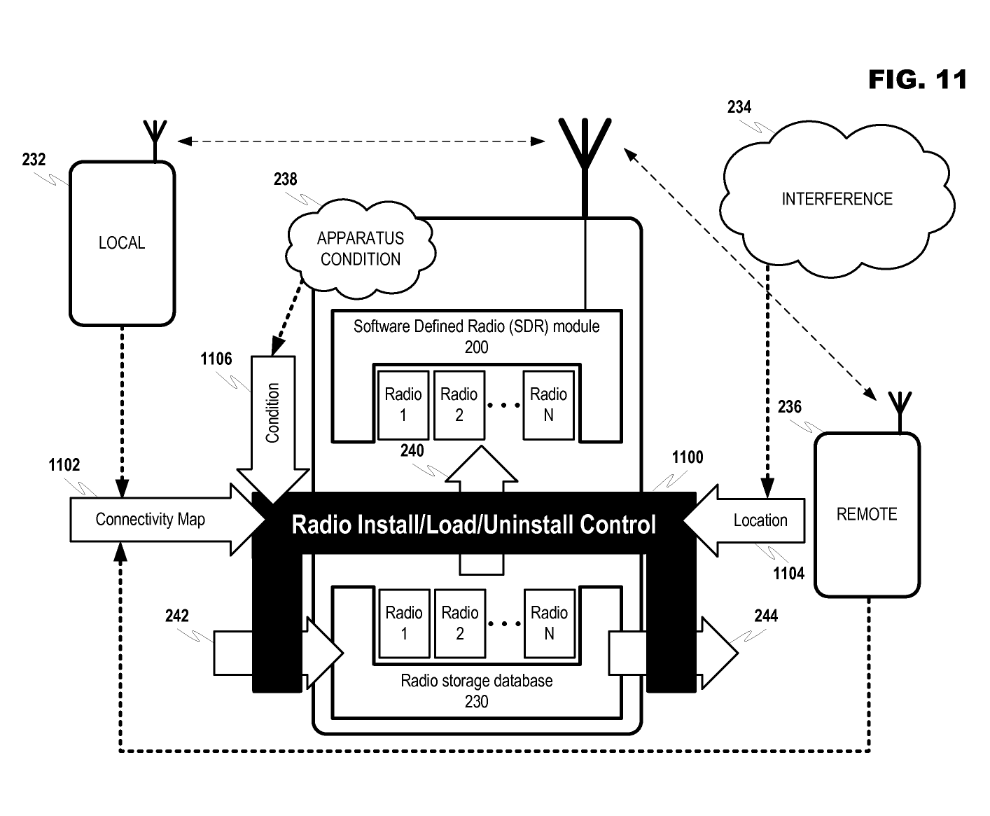

Now referring to FIG. 10, examples of location information that may be provided to/obtained by apparatuses are disclosed. Location information providers may encompass the information conduits 140 that were initially disclosed in FIG. 1 such as satellites, cellular/radio towers, other apparatuses (e.g., access points), etc. Apparatus 1000 may, for example, receive location information in one or more of the formats listed in FIG. 10. Coordinate system data may comprise positional information such as longitude and latitude, polar coordinates, etc. While many coordinate systems identify the absolute position of an object, relative coordinate systems are also available for determining location. For example, the position of an apparatus may be defined with respect to an access point (e.g., direction and distance from an access point), may be approximated via triangulation using information provided by cellular towers with which an apparatus is registered, etc. In still a third example, position may be characterized based on physical locations sensed in close proximity to an apparatus. Scanned machine-readable tags or received signals may identify an apparatus as in a particular city, on a particular street, inside of a structure or attending an event (e.g., concert, sporting event, convention, etc.). Location information, regardless of the format, may be used as decision criteria for selecting radios. This functionality, along with decision criteria provided via NoTA, is described further in FIG. 11.

### IX. Example Radio Selection Methodology

FIG. 11 introduces an example of the present invention, in accordance with at least one embodiment, to the operational scenario previously described with respect to FIG. 2B. Initially FIG. 11 assumes, for the sake of example, that the apparatus depicted centrally in FIG. 11 can operate using NoTA such as previously described herein. Radio Install/Load/Uninstall control 1100 may comprise hardware and/or software that is tasked with determining the radios to install in radio storage database 230, to load into SDR module 200 based on inputted decision criteria, and in some instances, the radios to uninstall from radio storage database 230. Example decision criteria that is usable by radio Install/Load/Uninstall control 1100 may comprise connectivity map information 1102, location information 1104 and apparatus condition information 1106. The possible ways in which this decision criteria may be used, in accordance with at least one embodiment of the present invention, will be described in further detail below.

Connectivity map information 1102 may provide insight into the apparatuses (e.g., local apparatuses 232 and remote apparatuses 236) that are currently participating in the NoTA environment. In particular, connectivity map 580 may tie services available in the NoTA environment to communication transports that are usable for accessing these resources. Upon identification of a required resource, the usable communication transports can be immediately limited to those identified in the connectivity map. The subset of communication transports that are usable with the desired service may be provided to radio Install/Load/Uninstall control 110 as a part of connectivity map information 1102 in order to limit the radios that are being considered for installation in radio storage database 230 and/or for loading into SDR module 200. In addition, configuration and/or functional information for other networked apparatuses may be available via the NoTA environment. This information may be useful as decision criteria when selecting or eliminating (e.g., marking as replaceable and/or uninstalling)_radios based on, for example, resource levels in apparatuses (such as processing load, power level and active transports), available support various communication transports in other apparatuses, traffic load/message backlog for particular communication transports, current quality of service (QoS) levels being observed for particular communication transports, etc.

Location information 1104 may comprise position-related information provided in absolute or relative terms such as previously described. This information may be provided via NoTA services included in connectivity map 580 or in a manner completely separate from any NoTA system components. In accordance with various embodiments of the present invention, location information may be correlated with operational environment information proximate to an apparatus, such as pertaining to interference 234. This correlation may include characteristics of areas that may be utilized by radio Install/Load/Uninstall control 1100 when deciding which radios to install and/or load. For example, certain operational environments may include known sources of interference 234. As a result, certain radios may be eliminated from the decision process in view of their susceptibility to this known interference. On the contrary, an area may have known communication resources (e.g., access points) that make the use of some radios more attractive.

Apparatus condition information 238 may be provided to radio install/load control 1100 in the form of condition-related decision criteria 1106. Apparatus condition may pertain to resources available on the apparatus (e.g., processing load, power level, free memory space, etc.) or activities occurring on the apparatus. Activities may comprise active processing tasks aside from communication-related processing, active communication transports, loading and/or message backlog for each active communication transport, current QoS levels being observed for each transport, pending message traffic that has not yet been allocated for transmission, etc.

The above examples of decision criteria merely represent types of data that may be considered by radio Install/Load/Uninstall control 1100 when determining whether to install radios into radio storage database 230 and/or load radios in SDR module 200. This control element may be a software program that is, for example, stored in memory 104 and executed by processor 102, may be hard-coded in an integrated circuit solution, or may comprise a combination of these technologies. In addition to determining when to install/load radios, radio Install/Load/Uninstall control 1100 may also determine when loaded radios can be replaced and/or uninstalled. In the instance of replacement, a currently loaded radio may be unloaded and/or uninstalled in favor of another radio. This activity may occur immediately upon realizing that a loaded radio is no longer needed, or alternatively, radios may be indicated as replaceable and may be replaced when a need for a new radio has been realized in the apparatus.

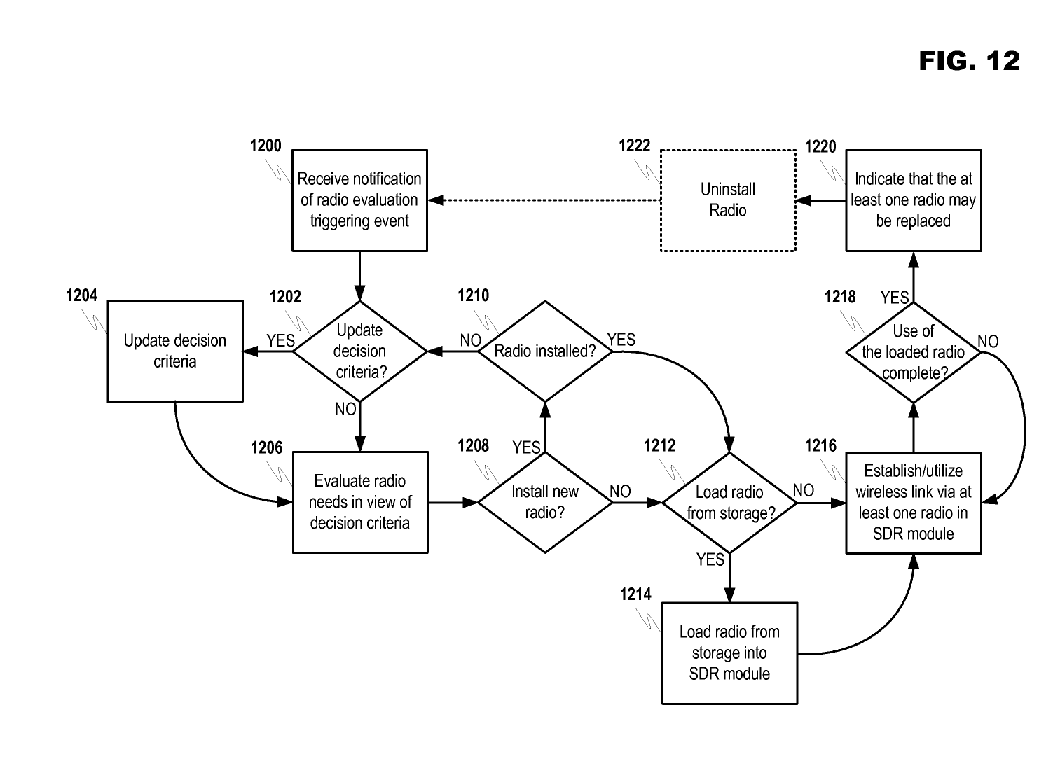

A flowchart of an example radio install/load/unload process in accordance with at least one embodiment of the present invention is now described with respect to FIG. 12. Initially a requirement for SDR module configuration may be realized in step 1200. This realization may occur due to, for example, one or more control entities in an apparatus receiving notification of an event that triggers radio evaluation in the apparatus. A determination may then be made in step 1202 as to whether decision criteria currently existing in the apparatus needs to be updated. The decision criteria may, for example, be determined to be old or expired, the update process may occur automatically due to a triggering event, due periodic update functionality, etc. If the decision criteria needs to be updated the process will move to step 1204 where the update occurs. Regardless of whether the decision criteria is updated, the process will then move to step 1206.

In step 1206 the decision criteria is evaluated in order to determine what actions need to be taken with respect to radio configuration in the apparatus. This evaluation may look at the activity that triggered the evaluation (e.g., a requirement for accessing a remote resource) in view of the decision criteria available to the apparatus, and may then determine if and how the radio configuration in the apparatus must be revised. After a new radio configuration has been determined, in step 1208 the new configuration may be utilized to determine whether new radios need to be installed. If one or more new radios are to be installed, then in step 1210 an attempt may be made to install these radios. The installation of new radios may occur in accordance with the examples previously described above. If any of the new radios could not be installed into the apparatus, then the process may return to step 1202 to update the decision criteria. For example, the decision criteria may be updated to indicate that the radios that needed to be installed are not available. If radio installation is successful in step 1210 the process may proceed to step 1212.

If no new radios were installed in step 1208 as part of the radio reconfiguration determined in step 1206, or if radios were successfully installed in step 1210, the process may proceed to step 1212 where a determination is made as to whether one or more radios should be loaded from storage in the apparatus into at least one SDR module also residing in the apparatus. If radios are to be loaded from storage (e.g., in view of the evaluation in step 1206), the process may move to step 1214 where the one or more radios are loaded from storage into the at least one SDR module. The process may then proceed to step 1216 wherein at least one of the one or more radios loaded into the at least one SDR module establish a new communication connection and utilize the communication connection to carry out whatever task triggered radio evaluation in step 1200 (e.g., accessing required resources residing on another apparatus). This process may continue until completion in step 1218, after which a realization is made that at least one of the radios loaded in the at least one radio module is no longer needed (e.g., there are no projected communication requirements for the radio). The process may then move to step 1220 where the at least one radio that is no longer needed is indicated as replaceable. The indication that a radio is replaceable may simply cause the radio to be unloaded from the at least one SDR module (e.g., the radio may still be retained in the radio storage database), or alternatively, an optional step 1222 may further determine whether the radio should be totally uninstalled from the apparatus. As previously stated, this may result in the radio being immediately unloaded and/or uninstalled, or being identified for unloading and/or total removal at a later time (e.g., when a new radio is ready to be loaded). The process may then return to step 1200 to await the next triggering event.

The various embodiments of the present invention are not limited only to the examples disclosed above, and may encompass other configurations or implementations.

For example, example embodiments of the present invention may encompass apparatuses comprising means for identifying a communication requirement in an apparatus, means for attempting to install radio software into radio software storage in the apparatus if it is determined, based on certain decision criteria, that radio software not already stored within the apparatus is needed to support the communication requirement, means for loading radio software from the radio software storage into a radio module in the apparatus if it is determined, based on the certain decision criteria, that at least one radio defined in the radio software is needed to support the communication requirement, and means for establishing a wireless communication link via the radio module using the at least one radio defined in the radio software.

At least one other example embodiment of the present invention may include electronic signals that cause apparatuses to identify a communication requirement in an apparatus, attempt to install radio software into radio software storage in the apparatus if it is determined, based on certain decision criteria, that radio software not already stored within the apparatus is needed to support the communication requirement, load radio software from the radio software storage into a radio module in the apparatus if it is determined, based on the certain decision criteria, that at least one radio defined in the radio software is needed to support the communication requirement, and establish a wireless communication link via the radio module using the at least one radio defined in the radio software.

Accordingly, it will be apparent to persons skilled in the relevant art that various changes in forma and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
identifying a communication requirement in an apparatus;
attempting to install radio software into radio software storage in the apparatus if it is determined, based on certain decision criteria, that radio software not already stored within the apparatus is needed to support the communication requirement;
loading radio software from the radio software storage into a radio module in the apparatus if it is determined, based on the certain decision criteria, that at least one radio defined in the radio software is needed to support the communication requirement; and
establishing a wireless communication link via the radio module using the at least one radio defined in the radio software.

2. The method of claim 1, wherein the certain decision criteria is based on one or more of connectivity map information, apparatus location or apparatus condition.

3. The method of claim 1, further comprising updating the certain decision criteria in the apparatus after the identification of the communication requirement if it is determined that the certain decision criteria needs to be updated.

4. The method of claim 1, wherein the radio module is a software defined radio (SDR) module into which radio software is loaded to define radio operation and protocol.

5. The method of claim 4, wherein the radio software defines the operation and protocol of one or more radios that may each be loaded or unloaded without affecting the operation of the remaining radios defined in the SDR module.

6. The method of claim 5, wherein any of the one or more radios in the SDR module is one or more of indicated as replaceable or uninstalled from the apparatus when it is determined that there is no further need for a radio.

7. A computer program product comprising computer executable program code recorded on a computer readable storage medium, the computer executable program code comprising:
code configured to identify a communication requirement in an apparatus;
code configured to attempt to install radio software into radio software storage in the apparatus if it is determined, based on certain decision criteria, that radio software not already stored within the apparatus is needed to support the communication requirement;
code configured to load radio software from the radio software storage into a radio module in the apparatus if it is determined, based on the certain decision criteria, that at least one radio defined in the radio software is needed to support the communication requirement; and
code configured to establish a wireless communication link via the radio module using the at least one radio defined in the radio software.

8. The computer program product of claim 7, wherein the certain decision criteria is based on one or more of connectivity map information, apparatus location or apparatus condition.

9. The computer program product of claim 7, further comprising updating the certain decision criteria in the apparatus after the identification of the communication requirement if it is determined that the certain decision criteria needs to be updated.

10. The computer program product of claim 7, wherein the radio module is a software defined radio (SDR) module into which radio software is loaded to define radio operation and protocol.

11. The computer program product of claim 10, wherein the radio software defines the operation and protocol of one or more radios that may each be loaded or unloaded without affecting the operation of the remaining radios defined in the SDR module.

12. The computer program product of claim 11, wherein any of the one or more radios in the SDR module is one or more of indicated as replaceable or uninstalled from the apparatus when it is determined that there is no further need for a radio.

13. An apparatus, comprising:
at least one processor; and
at least one memory including executable instructions, the at least one memory and the executable instructions being configured to, in cooperation with the at least one processor, cause the device to perform at least the following:
identify a communication requirement in an apparatus;
attempt to install radio software into radio software storage in the apparatus if it is determined, based on certain decision criteria, that radio software not already stored within the apparatus is needed to support the communication requirement;
load radio software from the radio software storage into a radio module in the apparatus if it is determined, based on the certain decision criteria, that at least one radio defined in the radio software is needed to support the communication requirement; and
establish a wireless communication link via the radio module using the at least one radio defined in the radio software.

14. The apparatus of claim 13, wherein the certain decision criteria is based on one or more of connectivity map information, apparatus location or apparatus condition.

15. The apparatus of claim 13, further comprising updating the certain decision criteria in the apparatus after the identification of the communication requirement if it is determined that the certain decision criteria needs to be updated.

16. The apparatus of claim 13, wherein the radio module is a software defined radio (SDR) module into which radio software is loaded to define radio operation and protocol.

17. The apparatus of claim 16, wherein the radio software defines the operation and protocol of one or more radios that may each be loaded or unloaded without affecting the operation of the remaining radios defined in the SDR module.

18. The apparatus of claim 17, wherein any of the one or more radios in the SDR module is one or more of indicated as replaceable or uninstalled from the apparatus when it is determined that there is no further need for a radio.

19. A system, comprising:
an apparatus; and
at least one other apparatus;
the apparatus identifying a communication requirement for communicating with the at least one other apparatus and attempting to install radio software into radio software storage if it is determined, based on certain decision criteria, that radio software not already stored within the apparatus is needed to support the communication requirement;
the at least one apparatus further loading radio software from the radio software storage into a radio module in the apparatus if it is determined, based on the certain decision criteria, that at least one radio defined in the radio software is needed to support the communication requirement, and establishing a wireless communication link with the at least one other apparatus via the radio module using the at least one radio defined in the radio software.
